(19) United States
(12) Patent Application Publication
(10) Pub. No.: US 2002/0145559 A1
(43) Pub. Date: Oct. 10, 2002

(54) Automatic remote time clock and employee location device

(76) Inventor: Matthew K. Sullivan, Yucca Valley, CA (US)

Correspondence Address: SHOEMAKER AND MATTARE, LTD., CRYSTAL PLAZA BUILDING 1, SUITE 1203, 2001 JEFFERSON DAVIS HIGHWAY, P.O. BOX 2286, ARLINGTON, VA, 22202-0286, US

(21) Appl. No.: 10/084,625

(22) Filed: Feb. 28, 2002

Related U.S. Application Data
(60) Provisional application No. 60/272,052, filed on Mar. 1, 2001.

(51) Int. Cl. G01S 5/14

(52) U.S. Cl. 342/357.07; 342/357.09

(57) ABSTRACT

A time and location keeper for employees includes a device which includes a power supply, a smart GPS receiver, and a data transmitter such as a cell phone. The components are worn on the person, for example in a compartmented belt. Time and location data are sent to a base station from the transmitter, which may be activated automatically on a schedule, or by a query signal from the base station.

### BACKGROUND OF THE INVENTION

This invention relates to a system for monitoring employees' hours and locations.

Accounting for the actual time an employee works at a particular job site is a serious problem for industries that dispatch numerous employees to multiple job sites throughout the day. Payroll departments are challenged to maintain correct hours in such situations. Employees who keep their own time cards tend to be optimistic about arrival and departure times, and usually fill out their time cards at the end of the day from recollection. Managers are also burdened by having to monitor time card entries in order to provide billing and job cost data for each job location. Businesses could reduce these problems if a reliable automatic time recording system, capable of monitoring employee hours at various job sites, were available to them.

The Global Positioning Satellite (GPS) system includes an array of satellites, in sufficient numbers to cover the entire globe, which broadcast synchronized time signals. A GPS receiver on the ground tuned to these signals can, by differentiating the receipt times and knowing the positions of the satellites, determine the position of the receiver. The longitude and latitude coordinates may be determined this way within a tolerance of about twenty feet. Prior inventors have proposed using GPS receivers to monitor the whereabouts of children and other people.

It would be beneficial for employers to have a GPS-based employee locator system which could generate position history data for each employee, to develop more precise, reliable and provable employee time histories.

### SUMMARY OF THE INVENTION

An object of the invention is to enable employers to keep track of employees' location and time.

A related object is to relieve the employee of responsibility for entering his location and times on time cards.

A further object it to enable an employer to automatically update job and labor logs on a daily basis.

One further object is to improve the accuracy of time records, and minimize fraud.

These and other objects are attained by a time and location keeper for employees as described below.

### BRIEF DESCRIPTION OF THE DRAWING

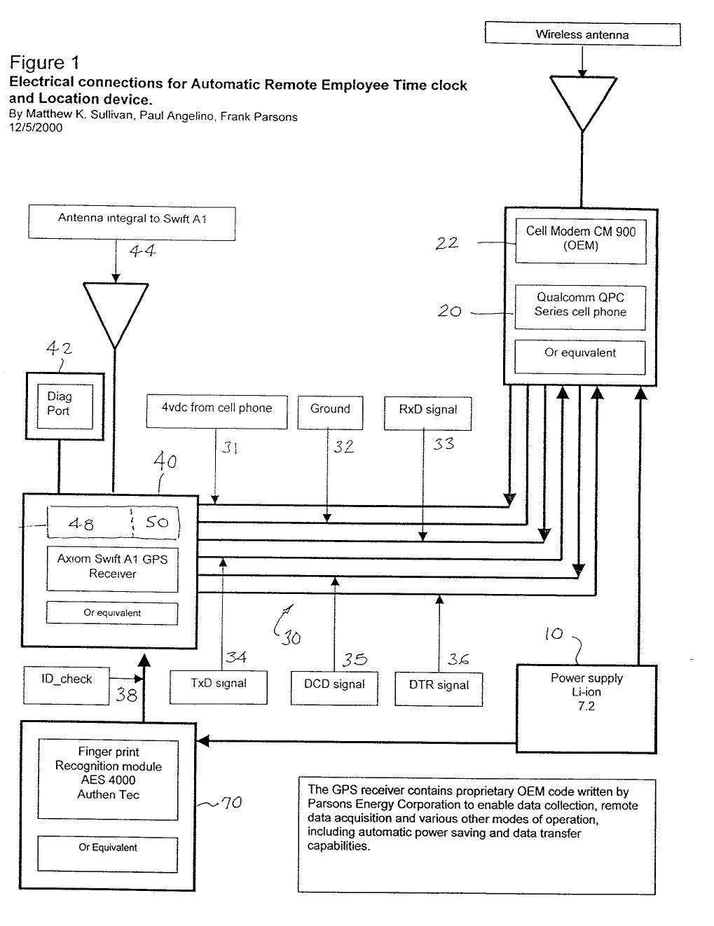

In the accompanying drawing, FIG. 1 is a schematic diagram of a location and time keeping system embodying the invention.

### DESCRIPTION OF THE PREFERRED EMBODIMENT

A time and location keeper for employees includes a device worn on the person, which includes a power supply, a smart GPS receiver, and a data transmitter such as a cell phone. The device is illustrated schematically in FIG. 1.

The time and location keeper may be built into a pants belt, or may have an hook for attaching the device to a belt of other article of clothing. The entire device may be made flexible, by installing the components on a flexible circuit board, or it may be incorporated in a conventional hard plastic shell. A belt containing the flexible components has compartments distributed along its length for a flexible circuit board (which includes the GPS receiver), a light emitting diode, a power supply, an antenna, and a fingerprint identification pad. The electronic components are embedded in flexible epoxy resin to render them waterproof and shock resistant.

As shown schematically in FIG. 1, a remote device carried or worn by a person includes a power supply 10, a wireless telephone including a cell phone 20 and a cell modem 22 for transferring data, a GPS receiver 40 which generates ground coordinate signals in digital format which are delivered to the telephone via a data bus, and a fingerprint recognition module 70. The fingerprint recognition module and the telephone receive power directly from the power supply and generate an authenticity signal on occasion. The GPS receiver receives its power indirectly, from the telephone via a six-conductor cable or bus 30.

The cell phone is, electronically, a Qualcomm QPC Series unit, or equivalent, preferably including a cell modem designated CM 900, or its equivalent. The phone is powered by the power supply shown, and has its own wireless antenna.

A GPS receiver 40 meeting the requirements of this invention is commercially available from Axiom Swift, model A1 GPS. It communicates with the cell phone via the cable or bus which has, in addition to a power line 31 and a ground 32, at least the paths 33,34,35,36 indicated on the drawing for, respectively, R×D (receive data), T×D (transmit data), DCD (data carrier detect), and DTD (data terminal ready) signals. A separate connection 38 receives authentication signal from the fingerprint reader. A diagnostics port 42 is shown at the upper left of the FIGURE, next to an integral antenna 44 for receiving signals from the GPS satellites.

The receiver identified above is preferred because it contains a processor (EEPROM) 46 having not only code space 48 reserved for its own operation, but also a substantial amount of extra code space 50 which may be loaded with user-defined code. The EEPROM preserves data if power is lost temporarily.

A suitable fingerprint identification unit is commercially available from Athen Tec, model AES 4000. It is loaded with data corresponding to the print of a specified digit of the employee. When that digit is pressed against the device, the print is optically read and compared with the stored data. If the actual and stored prints match, a logic signal indicating authenticity is provided to the receiver for use by the stored program. The authenticity signal is made a prerequisite for certain operations; conversely, the absence of an authenticity signal may be reported to the base station.

In operation, the device is normally inactive, but ready to respond when it receives an instruction to do so from the base station. Interrogations may be made at regular intervals or at an operator's discretion. When the cell phone receives a call from the base station, it activates the user code in the GPS receiver EEPROM. The program thereupon processes sample data received from the GPS receiver at frequent intervals, such as once per second. The data samples are converted into useful information—in binary, hex, ASCII, or other format—including the time of day and the geographical coordinates of the receiver. The coordinates indicate the longitude and latitude (and optionally the altitude) of the device. This information, preferably after being compressed, is transmitted from the cell phone automatically to a base station. A validation routine spots invalid data and generates an “invalid data” signal in that case.

The employee may be required to verify his presence at the receiver from time to time by touching the fingerprint identification pad. Authentication may also be required before one can activate or deactivate the device.

Rather than waiting to be queried, the device may be programmed to transmit data at predetermined hours or upon the occurrence of specific events. For example, it may automatically send data once every so often, or when there has been a certain amount of activity, for example when memory is nearly full.

The information is received at the base station, decompressed, and processed further to generate the desired employee time records.

The actual instructions used to implement the above process are matters of ordinary programming skill and are for that reason not specifically set forth herein.

I claim:

1. A time and location monitor comprising
a power supply,
a smart GPS receiver for producing geographic location data, and
a data transmitter connected to the data transmitter, for reporting said location data to a base station.

2. The invention of claim 1, wherein the data transmitter includes a cell phone.

3. The invention of claim 1, further comprising a fingerprint identification module, connected to the data transmitter, for authenticating the employee's presence at the monitor.

4. A method of recording an employee's movements, said method comprising steps of
causing the employee to wear a location monitor comprising a position sensor and a remotely actuable data transmitter,
remotely activating the data transmitter at regular or irregular time intervals in such a way as to cause the transmitter to broadcast data indicative of location, and
receiving and recording said data at a base station.

5. The method of claim 4, further comprising steps of
providing the location monitor with a fingerprint reader,
requiring the employee, during at least some of said intervals, to authenticate his presence by placing a digit against the fingerprint reader, and
issuing an alarm if said presence is not authenticated.
